(19) United States
(12) Patent Application Publication
(10) Pub. No.: US 2011/0189863 A1
(43) Pub. Date: Aug. 4, 2011

(54) BREAK-AWAY CONNECTION FOR IN-FLIGHT ENTERTAINMENT SYSTEM

(75) Inventors: Jeffrey S. Sare, San Clemente, CA (US); Kenneth A. Brady, JR., Trabuco Canyon, CA (US)

(73) Assignee: Thales Avionics, Inc., Irvine, CA (US)

(21) Appl. No.: 13/004,170

(22) Filed: Jan. 11, 2011

Related U.S. Application Data
(60) Provisional application No. 61/294,140, filed on Jan. 12, 2010.

(51) Int. Cl. H01R 11/30

(52) U.S. Cl. 439/39

(57) ABSTRACT

A break-away electrical connection for a passenger audio, audio/video, or data interface in an in-flight entertainment system comprises a magnetic retainer in either or both of a plug and receptacle and an asymmetric mechanical guide for proper alignment of signal polarity.

### CROSS-REFERENCE TO RELATED PATENT APPLICATION

This application claims the priority benefit of U.S. provisional patent application Ser. No. 61/294,140, filed on Jan. 12, 2010, and entitled “Break-Away Connection for In-Flight Entertainment,” the disclosure of which is incorporated herein in its entirety by reference.

### BACKGROUND

Embodiments generally relate to a electrical connectors, and more specifically to a break-away connection between an in-flight entertainment (IFE) system and passenger interfaces such as audio head-sets and other information connections.

In-flight entertainment systems have been deployed onboard aircraft to provide entertainment for passengers in a passenger cabin. The in-flight entertainment systems typically provide passengers with video and audio programming. Some in-flight entertainment systems include an electronic communications network having a head-end server and seat-end electronics boxes coupled with video display units that display content distributed to the seat-end electronics boxes from the head-end server over the communications network and controllers that facilitate a user's control of the content displayed on the video display units. The in-flight entertainment systems typically also provide interfaces for the attachment of audio headsets. Some in-flight entertainment systems also provide interfaces for connecting personal peripheral devices such as video cameras through audio/video input ports, and personal peripheral data connections such as universal serial bus (USB) ports.

Typically, in-flight audio, video, and data interfaces are installed at each passenger seat, or at each passenger seat. Standard commercial connectors are used in these interfaces to connect the passenger equipment to the interface at the seat. These include, for example, audio receptacles and jacks, USB type A receptacles and plugs, and RCA plugs and receptacles. These connectors are not designed to sustain the use and abuse that occur in the confined space of an aircraft passenger seat area.

The labor costs of having licensed aircraft mechanics replace worn out or damaged connectors and receptacles at passenger seats, for example due to a broken pin, are a serious problem. In addition, many airlines find it necessary to reimburse passengers an amount of money to make up for a long flight where entertainment was not available to them because of damaged connectors and receptacles. A less tangible problem is the cost of lost customer goodwill or poor passenger perception when passengers must wiggle their head-set jack to obtain audio entertainment. Passengers can perceive intermittent contacts, which often remain unreported for a substantial period of time, as evidence of poor maintenance or a lack of care on the part of the airline.

### SUMMARY

According to an embodiment, an electrical connector includes a receptacle having an asymmetric shape which facilitates removable seating of a plug having a corresponding asymmetric shape. The electrical connector also includes a plurality of electrical contacts disposed within the receptacle, each electrical contact being electrically insulated from the other electrical contacts of the plurality of electrical contacts. A magnetic retainer is disposed within the receptacle, the magnetic retainer having sufficient magnetic force to magnetically hold the plug seated in position in the receptacle. The asymmetric shape may be a wedge shape. The plurality of electrical contacts may be ball contacts. At least some of the plurality of electrical connectors may conduct audio signals. At least some of the plurality of electrical connectors may conduct Universal Serial Bus data signals.

According to another embodiment, an electrical connector includes a plug having an asymmetric shape which facilitates removable seating of the plug into a receptacle having a corresponding asymmetric shape. The electrical connector also includes a plurality of electrical contacts disposed within the plug, each electrical contact being electrically insulated from the other electrical contacts of the plurality of electrical contacts. A ferromagnetic material is disposed within the plug, the ferromagnetic material sufficiently attractive to a magnetic force of a magnetic retainer of the receptacle to magnetically hold the plug seated in position in the receptacle. The asymmetric shape may be a wedge shape. The plurality of electrical contacts may be ball contacts. At least some of the plurality of electrical connectors may conduct audio signals. At least some of the plurality of electrical connectors may conduct Universal Serial Bus data signals. The ferromagnetic material may include a magnet having a polarity complementary to the magnetic retainer of the receptacle.

According to another embodiment, an electrical connector assembly includes a plug and a corresponding receptacle that mates with the plug. The plug has a first plurality of electrical contacts disposed in a first arrangement, each of the first plurality of electrical contacts being electrically insulated from the other electrical contacts of the first plurality of electrical contacts. The receptacle has a corresponding shape to the plug which facilitates removable seating of the plug into the receptacle, the receptacle having a second plurality of electrical contacts disposed in a second arrangement which corresponds to the first arrangement such that each of the second plurality of electrical contacts of the receptacle electrically connects with a respective one of the first plurality of electrical contacts of the plug. Each of the second plurality of electrical contacts is electrically insulated from the other electrical contacts of the second plurality of electrical contacts. A first magnetic retainer is disposed within the plug, the first magnetic retainer having a magnetic polarity oriented from one end region of the plug to an opposite end region of the plug. A second magnetic retainer is disposed within the receptacle, the second magnetic retainer having a magnetic polarity oriented from one end region of the receptacle corresponding to the opposite end region of the plug to an opposite end region of the receptacle corresponding to the one end region of the plug, the orientation of the magnetic polarity of the second magnetic retainer being complementary to the orientation of the magnetic polarity of the first magnetic retainer such that the mated magnetic retainers of the plug and the receptacle have sufficient magnetic force to magnetically hold the plug seated in position in the receptacle in only a single orientation. The plug and receptacle may both have a symmetric shape. The first plurality of electrical contacts may be ball contacts. At least some of the first and second plurality of electrical connectors may conduct audio signals. At least some of the first and second plurality of electrical connectors may conduct Universal Serial Bus data signals. The first magnetic retainer may include a first plurality of magnetic retainers having alternating magnetic polarities from adjacent magnetic retainers, and the second magnetic retainer may include a second plurality of magnetic retainers having alternating magnetic polarities from adjacent magnetic retainers in which the magnetic polarities of each one of the first plurality of magnetic retainers is complementary to the respective one of the second plurality of magnetic retainers. The second magnetic retainer may be a single magnet having a polarity oriented from north to south along a surface of the receptacle.

### BRIEF DESCRIPTION OF THE DRAWINGS

FIGS. 1A and 1B illustrate a conventional audio interface for an aircraft passenger audio headset during normal operation.

FIG. 2A illustrates the conventional audio interface of FIGS. 1A and 1B when a shear force causes the audio jack to break.

FIG. 2B illustrates the conventional audio interface of FIGS. 1A and 1B when repeated pressure causes a spring contact of the audio jack receptacle to become a bent contact.

FIGS. 3A and 3B illustrate a break-away connection between a removable plug 220 and a plug receptacle 210 in a connected and disconnected state, respectively, according to an embodiment.

FIGS. 4A and 4B illustrate a plug receptacle polarized using a wedge shape, according to an embodiment.

FIGS. 4C and 4D illustrate a plug polarized using a wedge shape that mates with the receptacle of FIGS. 4A and 4B, according to an embodiment.

FIG. 5A illustrates a receptacle, according to another embodiment.

FIG. 5B illustrates a plug that mates with the receptacle of FIG. 5A, according to another embodiment.

### DETAILED DESCRIPTION

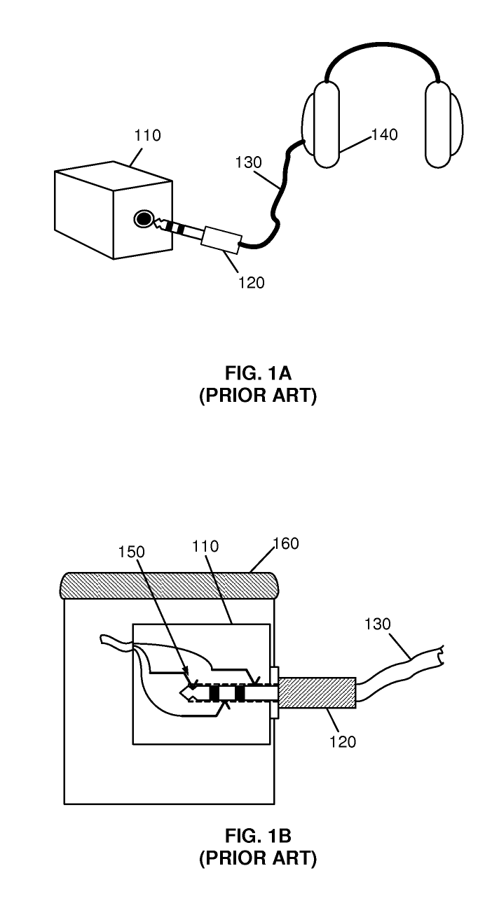

FIGS. 1A and 1B illustrate a conventional audio interface for an aircraft passenger audio headset during normal operation. The audio interface includes a 3.5 mm audio jack 120 and audio jack receptacle 110. While the jack 120 and receptacle 110 illustrated and discussed with reference to FIGS. 1A and 1B are for an audio interface, this should not be construed as limiting. For example, the jack 120 and receptacle 110 may include jacks and receptacles for other types of electrical interfaces as known in the art besides an audio interface as illustrated, such as a Universal Serial Bus (USB) interface. Various jacks and receptacles for deployment at passenger seats in aircraft are described in the standard document ARINC Specification 628, and in particular Part 2 (628P2-6) “Cabin Equipment Interfaces, Part 2, Cabin Management and Entertainment Systems—Seat Interfaces” (ARINC Inc., 2551 Riva Road, Annapolis, Md., http://www.arinc.com).

The audio jack 120 is disposed at the end of a headset cord 130, which is part of an audio headset 140. The audio jack 120 is insertable into the audio jack receptacle 110, which is typically installed somewhere proximate to an aircraft seat. In an example in which the audio jack receptacle 110 is installed into a seat arm 160, an entry hole of the receptacle 110 protrudes through a hole in the seat arm 160. The audio jack 120 is inserted into the audio jack receptacle 110 when a user desires to listen to the available audio of the in-flight entertainment system. The audio receptacle 110 typically includes a plurality of spring contacts 150 which contact electrically conducting portions of the audio jack 120 to conduct audio signals from the in-flight entertainment system to the audio headset 140 through the headset cord 130. One or more of the plurality of spring contacts 150 may also provide a retention function by seating into a recessed portion of the jack 120. Typically, one of the spring contacts 150 provides a ground signal connection, one provides a left channel signal connection, and one provides a right channel signal connection.

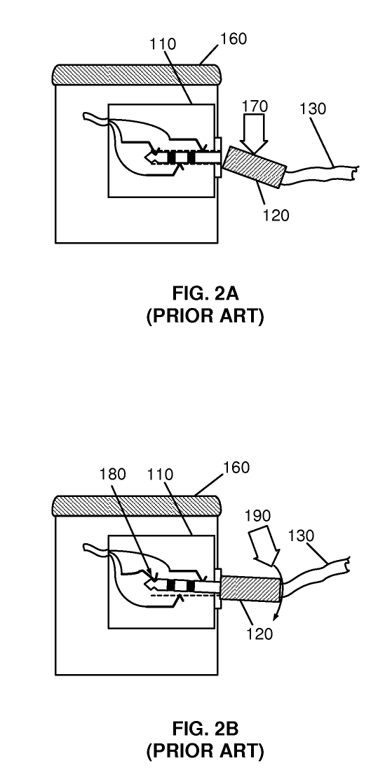

FIG. 2A illustrates the conventional audio interface of FIGS. 1A and 1B when a shear force 170 causes the audio jack 120 to break. When embedded in the seat arm 160 or similar locations, the audio jack 120 is typically exposed to a variety of shearing forces 170 caused by physical contact with the jack 120 or the headset cord 130. Such physical contact often occurs as arms, elbows, legs, or feet generally move in a direction transverse to the direction in which the jack 120 inserts into the receptacle 110. Shearing forces 170 occasionally break off the pin at the end of the audio jack 120 while still inserted in the receptacle 110. When this occurs, not only is the jack 120 unusable, but the receptacle 110 is also unusable. As a result, a time intensive and expensive maintenance operation is required to repair or replace the audio jack receptacle 110. In the mean time, the passenger seated at the seat having the audio jack receptacle 110 is unable to use the audio jack receptacle 110 to listen to audio from the in-flight entertainment system, which results in great inconvenience and dissatisfaction and leave a negative impression about the aircraft or the airline that operates the aircraft.

FIG. 2B illustrates the conventional audio interface of FIGS. 1A and 1B when repeated pressure 190 causes a spring contact 150 of the audio jack receptacle 110 to become a bent contact 180. Even if no force is sufficient to shear off the pin of the jack 120 as illustrated in FIG. 2A, repeated mechanical strain 190 to the jack 120 can weaken one or more of the spring contacts 150 by bending until the one or more of the spring contacts 150 becomes a permanently bent contact 180. Once bent beyond a certain angle, the bent contact 180 no longer provides a proper electrical connection with the respective electrically conductive portion of the jack 120. In fact, bent contacts 180 are the primary sources of intermittent audio in an aircraft in-flight entertainment system. A passenger may identify a problem with bent contacts 180 and sometimes temporarily establish electrical contact using the bent contacts 180 by wiggling the jack 120 in order to listen to the audio content provided by the in-flight entertainment system. This is not an actual solution to the problem, and causes the passenger inconvenience and dissatisfaction which leaves a negative impression about the aircraft or the airline that operates the aircraft.

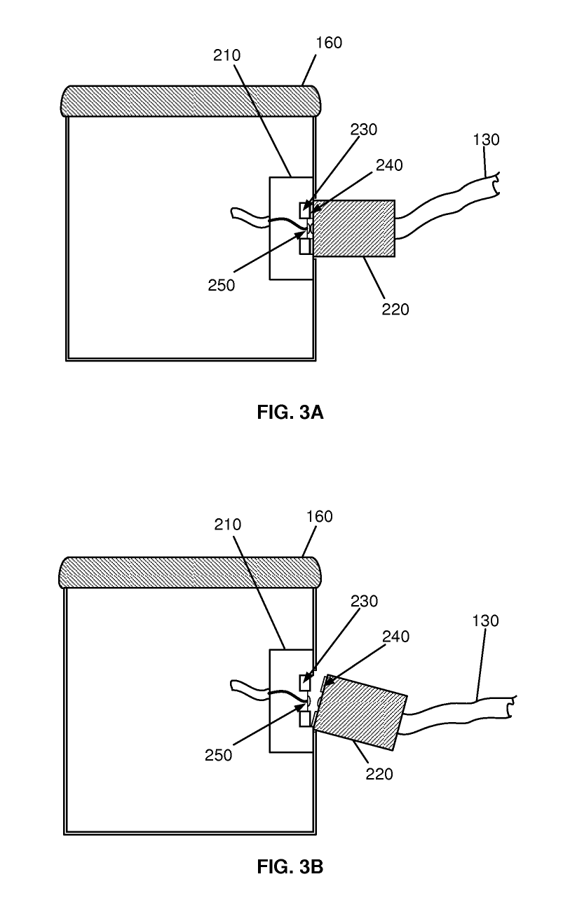

FIGS. 3A and 3B illustrate a break-away connection between a removable plug 220 and a plug receptacle 210 in a connected and disconnected state, respectively, according to an embodiment. The removable plug 220 is attached to the end of the headset cord 130. As illustrated in FIGS. 3A and 3B, a magnetic retainer 230 on the plug receptacle 210 holds the removable plug 220 to the plug receptacle 210. The magnetic retainer 230 attracts a ferromagnetic material 240 on the removable plug 220. In other embodiments, the magnetic retainer 230 and the ferromagnetic material 240 may be exchanged with one another or replaced with other mutually magnetically attractive materials as known by one of ordinary skill in the art, such as magnets having opposite polarities, without departing from the spirit of the invention as defined by the following claims.

Electrical contacts 250 located on both the plug receptacle 210 and the removable plug 220 are held in contact with one another by the mating magnetic materials of the plug receptacle 210 and the removable plug 220. The electrical contacts 250 may include metal pins or rods, or other types of electrically conductive materials as known by one of ordinary skill in the art. A surface of some or all of the electrical contacts 250 may be shaped as ball contacts, recessed cups in which ball contacts may be seated, or substantially flat. The electrical contacts 250 may be spring-loaded such that when the plug receptacle 210 and the removable plug 220 are mated, a spring-like force holds the mated pairs of electrical contacts 250 against one another with a force less than the magnetic force that holds the plug receptacle 210 and the plug 220 together. There may be a plurality of mating sets of electrical contacts 250 such that one set transmits a ground signal, one set transmits a left channel audio signal, and one set transmits a right channel audio signal.

Due to the break-away connection between the removable plug 220 and the plug receptacle 210, any substantial contact or pressure on the removable plug 220, either directly or indirectly through the headset cord 130, may overcome the magnetic attraction between the magnetic retainer 230 and the ferromagnetic material 240 and break the connection without the possibility of damage to either the removable plug 220 or the plug receptacle 210. Use of the magnetic retainer 230 on the plug receptacle 210 in conjunction with the ferromagnetic material 240 on the removable plug 220 substantially avoids the damage caused by shearing forces applied to the jack 120 and receptacle 110 of the prior art by permitting the plug 220 to break-away smoothly and without damage in the event that a large transverse force is suddenly applied to the plug 220 and/or plug receptacle 210.

In addition, the break-away connection between the removable plug 220 and the plug receptacle 210 provides a more user-friendly mechanism for passengers to engage the plug 220 with the plug receptacle 210. In some cases, the clearance between a passenger and the seat in front of the passenger is insufficient to permit the passenger to see where the receptacle 210 is located on the seat arm 160. In such cases, passengers may engage the plug 220 and receptacle 210 with each other by using tactile feedback from their fingers alone. The magnetic retainer 230 assists passengers that seek to engage the plug 220 and the receptacle 210 by feel by providing a magnetic force which actively pulls the plug 220 into proper alignment with receptacle 210 such that the respective sets of electrical contacts 250 are firmly connected with each other.

Furthermore, the break-away connection between the removable plug 220 and the plug receptacle 210 enables the plug receptacle 210 to be substantially smaller than the receptacle 110 of the prior art, because the receptacle 210 does not need to have a depth sufficient to accept and grip the full pin of the jack 120. Instead, electrical contact is made on an exterior surface of the receptacle 210 between electrical contacts 250 of the receptacle 210 and corresponding electrical contacts 250 of the jack 220. For example, while a receptacle 110 of the prior art may have a size of approximately one inch thick, the receptacle 210 may have a size of only 0.25 to 0.3 to 0.5 inches thick. Thus, the total size of the receptacle 210 may be approximately one inch high by one inch wide by one quarter inch thick. The smaller size of the receptacle 210 improves the flexibility and efficiency of integrating and installing the receptacle 210 into a seat arm of an aircraft.

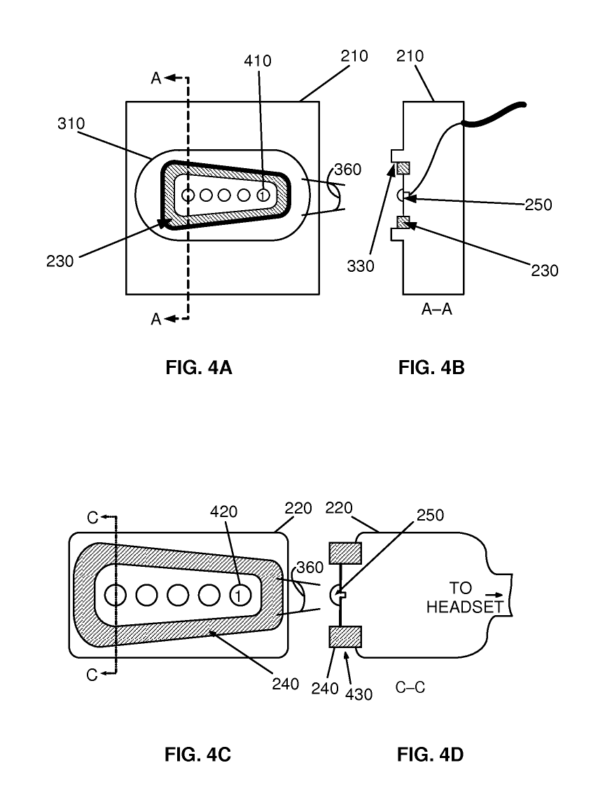

FIGS. 4A and 4B illustrate a plug receptacle 210 polarized using a wedge shape 360, according to an embodiment. FIG. 4B illustrates the cross section A-A indicated in FIG. 4A. FIGS. 4C and 4D illustrate a plug 220 polarized using a wedge shape 360 that mates with the receptacle 210 of FIGS. 4A and 4B, according to an embodiment. FIG. 4D illustrates the cross section C-C indicated in FIG. 4C. The plug receptacle 210 includes a cutout protrusion 310, which is compatible with the cutout used for existing traditional audio jack receptacles 110. The magnetic retainer 230 is recessed into a magnetic recess 330 in the plug receptacle 210 to reduce a potential for the magnetic retainer 230 to come into contact with magnetic sensitive materials such as magnetic credit card stripes. The plug 220 includes electrical contacts 250 which may be forced into contact with the corresponding electrical contacts 250 of the plug receptacle 210 when the plug 220 and the plug receptacle 210 are mated with each other. While four electrical contacts 250 are illustrated in each of the plug 220 and the receptacle 210, this should not be construed as limiting. In various embodiments, more or fewer electrical contacts 250 may be included, as appropriate for the application in which the breakaway connection using the plug 220 and receptacle 210 may be used. These applications may include audio output, audio/video input, USB data connections, low voltage power connections, etc.

It is important to differentiate between the signal types in an electrical connection between a jack and a receptacle and ensure that only the correct electrical connections are made. For example, traditional pairs of audio jacks 120 and receptacles 110 as illustrated in FIGS. 1A and 1B ensure that each of the left and right channel audio signals from the in-flight entertainment system in the receptacle 110 mates with the respective left and right channel audio signal lines in the headphone audio jack 120 when the jack 120 is properly inserted into the receptacle 110. Likewise, in a USB data application, a traditional USB receptacle and jack pair ensures that the D+ and D− signals from the host in the USB receptacle mate with the respective D+ and D− signal lines in the USB plug. A similar requirement would apply to audio/video input ports, specifically pertaining to the video signal and the left and right audio channel signal connections.

The breakaway connection illustrated in FIGS. 4A-4D use a polarized shape to ensure that the electrical contacts 250 in the receptacle 210 only mate with their intended respective electrical contacts 250 in the plug 220. In particular, the magnetic recess 330 also serves as a mechanical alignment aid, ensuring that the plug 220 and plug receptacle 210 properly align the electrical contacts 250 when mated with each other. The magnetic recess 330 forms a wedge shape 360, and the protrusion 430 of the plug 220 includes ferromagnetic material 240 formed into a wedge shape 360 which matches the wedge shape 360 of the magnetic recess 330 of the plug receptacle 210. Therefore, the plug receptacle 210 and the plug 220 are polarized such that the plug 220 may be inserted and mated with the plug receptacle 210 having the magnetic retainer 230 in only one orientation. In particular, the first electrical connector 420 of the plug 220 may only connect with the first electrical connector 410 of the receptacle 210, and not another electrical connector 250. In other embodiments, the polarized connection may be accomplished using another shape besides the illustrated wedge shape 360, such as one of any number of other asymmetric shapes such as a generally elliptical shape having a notch or flat portion to ensure a polarized connection.

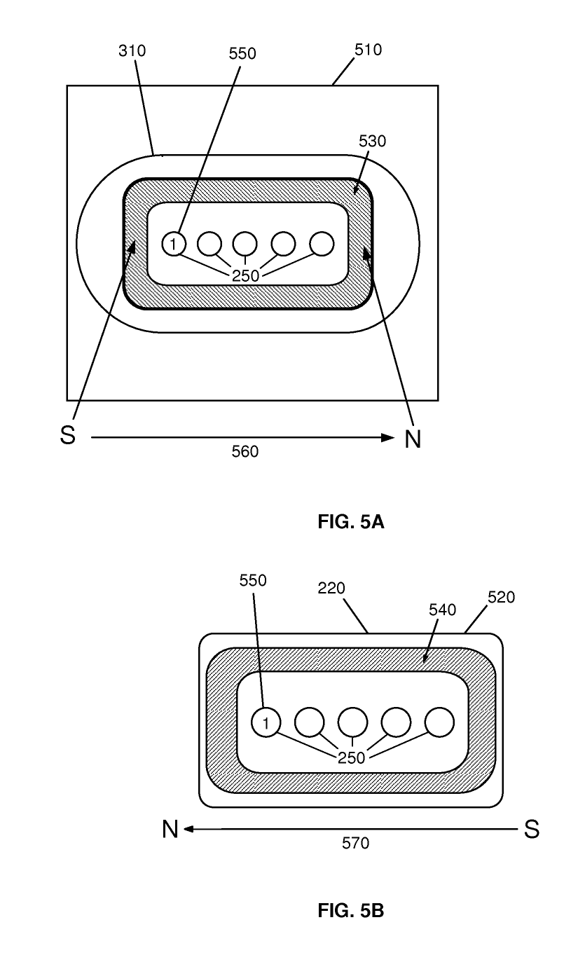

FIG. 5A illustrates a receptacle 510, and FIG. 5B illustrates a plug 520 that mates with the receptacle 510 of FIG. 5A, according to another embodiment. In the embodiment illustrated in FIGS. 5A and 5B, both the rectangular shaped receptacle 510 and plug 520 contain magnetic retainers 530 and 540, respectively, which have complementary magnetic orientations 560 and 570. As illustrated, the magnetic retainer 530 has a magnetic south pole at an end of the receptacle 510 in which a first electrical contact 550 is positioned, while the magnetic retainer 540 has a magnetic north pole at an end of the plug 520 in which a corresponding first electrical contact 550 is positioned. In this embodiment, the magnetic polarity of the magnetic retainers 530 and 540 ensure the proper alignment and orientation of the first electrical contacts 550 between the receptacle 510 and the plug 520 independently of a shape of the receptacle 510 and plug 520. Thus, the receptacle 510 and plug 520 may be shaped into a simple rectangle yet still maintain a polarized connection because of the polarity of the magnetic retainers 530 and 540.

In other embodiments, the magnetic retainers 530 and 540 may have other complementary magnetic polarizations than illustrated in FIGS. 5A and 5B. In some embodiments, each of the magnetic retainers 530 and 540 may include a plurality of distinct magnetic retainers that are complementary with one another to ensure proper alignment and orientation of the receptacle 510 and the plug 520 according to the principles illustrated. The receptacle 510 and plug 520 may also be formed into different shapes than illustrated, such as circular, elliptical, square, octagonal, etc.

In still another alternative embodiment, both magnetic retainers 530 and 540 and asymmetric mechanical guides (such as the wedge shape 360 or one of any number of other polarized shapes such as generally elliptical having a notch or flat portion) may be used in conjunction with one another to ensure proper alignment and orientation, permit non-destructive break-away of the plug from the receptacle, and provide tactile feedback to assist passengers in connecting plugs to receptacles by feel.

Because of the polarized connection between the plug 520 and the receptacle 510, the electrical contacts 250 may be arranged in a regular pattern as illustrated and do not need to be arranged in a specific polarized pattern that only provides connections when the plug 520 and the receptacle 510 are oriented in the correct manner. However, this should not be construed as limiting. In some embodiments, the electrical contacts 250 may also be arranged in a specific polarized pattern that only provides connections when the plug 520 and the receptacle 510 are oriented in the correct manner.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

We claim:

1. An electrical connector comprising:
a receptacle having an asymmetric shape which facilitates removable seating of a plug having a corresponding asymmetric shape;
a plurality of electrical contacts disposed within the receptacle, each electrical contact being electrically insulated from the other electrical contacts of the plurality of electrical contacts; and
a magnetic retainer disposed within the receptacle, the magnetic retainer having sufficient magnetic force to magnetically hold the plug seated in position in the receptacle.

2. The electrical connector of claim 1, wherein the asymmetric shape is a wedge shape.

3. The electrical connector of claim 1, wherein the plurality of electrical contacts are ball contacts.

4. The electrical connector of claim 1, wherein at least some of the plurality of electrical connectors conduct audio signals.

5. The electrical connector of claim 1, wherein at least some of the plurality of electrical connectors conduct Universal Serial Bus data signals.

6. An electrical connector comprising:
a plug having an asymmetric shape which facilitates removable seating of the plug into a receptacle having a corresponding asymmetric shape;
a plurality of electrical contacts disposed within the plug, each electrical contact being electrically insulated from the other electrical contacts of the plurality of electrical contacts; and
a ferromagnetic material disposed within the plug, the ferromagnetic material sufficiently attractive to a magnetic force of a magnetic retainer of the receptacle to magnetically hold the plug seated in position in the receptacle.

7. The electrical connector of claim 6, wherein the asymmetric shape is a wedge shape.

8. The electrical connector of claim 6, wherein the plurality of electrical contacts are ball contacts.

9. The electrical connector of claim 6, wherein at least some of the plurality of electrical connectors conduct audio signals.

10. The electrical connector of claim 6, wherein at least some of the plurality of electrical connectors conduct Universal Serial Bus data signals.

11. The electrical connector of claim 6, wherein the ferromagnetic material comprises a magnet having a polarity complementary to the magnetic retainer of the receptacle.

12. An electrical connector assembly comprising:
a plug having a first plurality of electrical contacts disposed in a first arrangement, each of the first plurality of electrical contacts being electrically insulated from the other electrical contacts of the first plurality of electrical contacts;
a receptacle having a corresponding shape to the plug which facilitates removable seating of the plug into the receptacle, the receptacle having a second plurality of electrical contacts disposed in a second arrangement which corresponds to the first arrangement such that each of the second plurality of electrical contacts of the receptacle electrically connects with a respective one of the first plurality of electrical contacts of the plug, each of the second plurality of electrical contacts being electrically insulated from the other electrical contacts of the second plurality of electrical contacts;
a first magnetic retainer disposed within the plug, the first magnetic retainer having a magnetic polarity oriented from one end region of the plug to an opposite end region of the plug;
a second magnetic retainer disposed within the receptacle, the second magnetic retainer having a magnetic polarity oriented from one end region of the receptacle corresponding to the opposite end region of the plug to an opposite end region of the receptacle corresponding to the one end region of the plug, the orientation of the magnetic polarity of the second magnetic retainer being complementary to the orientation of the magnetic polarity of the first magnetic retainer such that the mated magnetic retainers of the plug and the receptacle have sufficient magnetic force to magnetically hold the plug seated in position in the receptacle in only a single orientation.

13. The electrical connector assembly of claim 12, wherein the plug and receptacle have a symmetric shape.

14. The electrical connector assembly of claim 12, wherein the first plurality of electrical contacts are ball contacts.

15. The electrical connector assembly of claim 12, wherein at least some of the first and second plurality of electrical connectors conduct audio signals.

16. The electrical connector assembly of claim 12, wherein at least some of the first and second plurality of electrical connectors conduct Universal Serial Bus data signals.

17. The electrical connector assembly of claim 12, wherein the first magnetic retainer comprises a first plurality of magnetic retainers having alternating magnetic polarities from adjacent magnetic retainers, and the second magnetic retainer comprises a second plurality of magnetic retainers having alternating magnetic polarities from adjacent magnetic retainers in which the magnetic polarities of each one of the first plurality of magnetic retainers is complementary to the respective one of the second plurality of magnetic retainers.

18. The electrical connector assembly of claim 12, wherein the second magnetic retainer is a single magnet having a polarity oriented from north to south along a surface of the receptacle.
